(19) United States
(12) Patent Application Publication
(10) Pub. No.: US 2023/0283122 A1
(43) Pub. Date: Sep. 7, 2023

(54) ELECTRICAL MACHINE FOR A MOTOR VEHICLE

(71) Applicant: Dr. Ing. h.c. F. Porsche Aktiengesellschaft, Stuttgart (DE)

(72) Inventors: David BAUER, Asperg (DE); Josef DUBSKY, Friolzheim (DE); Tobias ENGELHARDT, Stuttgart (DE)

(21) Appl. No.: 18/177,146

(22) Filed: Mar. 2, 2023

(30) Foreign Application Priority Data
Mar. 7, 2022 (EP) 22020094.3

(51) Int. Cl. H02K 1/16; H02K 3/24; H02K 9/19; H02K 21/14

(52) U.S. Cl. CPC H02K 1/165; H02K 3/24; H02K 9/19; H02K 21/14; H02K 2213/03

(57) ABSTRACT

An electrical machine for a motor vehicle, including a stator including a stator body, wherein the stator body includes alternating stator teeth and stator grooves having conductors arranged therein. A yoke portion having a radially extending yoke height is formed on the stator body radially outside of the stator grooves. The stator body includes a stator outer radius, and a ratio of the yoke height to the stator outer radius is between 0.18 and 0.26.

### CROSS REFERENCE TO RELATED APPLICATIONS

This application claims benefit to European Patent Application No. EP 22020094.3, filed on Mar. 7, 2022, which is hereby incorporated by reference herein.

### FIELD

The invention relates to an electrical machine for a motor vehicle.

### BACKGROUND

U.S. Pat. No. 9,755,463 B2 discloses an electrical machine having a first carrier with electromagnetic elements and a second carrier with electromagnetic elements, wherein the second carrier is able to move relative to the first carrier. The electrical machine has a high current density but a complex construction.

DE 10 2018 112 347 A1 discloses an electrical machine having a stator and a stator sheet metal package, wherein conductor elements are arranged in the stator sheet metal package and cooled by coolant channels. This favors high current densities, but there is also potential for optimization.

### SUMMARY

In an embodiment, the present disclosure provides an electrical machine for a motor vehicle, comprising a stator including a stator body, wherein the stator body includes alternating stator teeth and stator grooves having conductors arranged therein. A yoke portion having a radially extending yoke height is formed on the stator body radially outside of the stator grooves. The stator body comprises a stator outer radius, and a ratio of the yoke height to the stator outer radius is between 0.18 and 0.26.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a schematic longitudinal section of an electrical machine; and

FIG. 2 illustrates a partial section of the electrical machine of FIG. 1 along a section axis A-A shown in FIG. 1.

### DETAILED DESCRIPTION

In an embodiment, the invention provides an improved electrical machine. It is desirable to provide an electrical machine with comparatively high current density and increased efficiency by constructively simple means.

The electrical machine is for a motor vehicle. The electrical machine comprises a stator comprising a stator body (stator sheet metal package), wherein the stator body (along a circumferential direction) alternately comprises stator teeth and stator grooves, wherein one or more conductor elements are respectively arranged in the stator grooves. On the stator body, a yoke portion having a radially extending yoke height is formed radially outside of the stator grooves and the stator teeth. The stator body has a stator outer radius. The ratio v₁ of the yoke height to the stator outer radius is between 0.18 and 0.26 (0.18≤ratio v₁≤0.26).

The comparatively large yoke height favors a high efficiency of the electrical machine, which is achieved by an increased sheet metal percentage in the stator and thus a comparatively high current density. This leads to a reduction in iron losses and thus an increased efficiency of the electrical machine.

In particular, the ratio v₁ of the yoke height relative to the stator outer radius can be between 0.20 and 0.24 (0.20≤ratio v₁≤0.24), further preferably between 0.21 and 0.23 (0.21≤ratio v₁≤0.23). In a specific example, the ratio v₁ of yoke height relative to the stator outer radius can be 0.22 (ratio v₁=0.22). By designing the stator body with these ratios, the efficiency of the machine can be further optimized.

In particular, the electrical machine is a traction motor for a motor vehicle. The electrical machine is configured and/or intended to drive a motor vehicle, preferably alone (traction drive). The vehicle is in particular a semi-electrically or fully-electrically driven motor vehicle (electric vehicle), in particular a passenger car, such as a sports car. The conductor elements are in particular stator windings.

The yoke portion forms a ring portion of the stator body closed along the circumferential direction. The stator body extends along an axial direction. The stator teeth and stator grooves also extend along or parallel to the axial direction.

Preferably, the stator body can have a stator inner radius, wherein the ratio v₂ of the stator inner radius to the stator outer radius is between 0.61 and 0.69 (0.61≤ratio v₂≤0.69). Thus, a comparatively low inner stator radius results. This in turn leads to an increased sheet metal percentage in the stator, which increases efficiency. Due to the low inner stator radius, the rotor outer radius can be kept low, which leads to reduced friction losses and thus to increased efficiency. The stator outer radius can also be kept comparatively low.

In particular, the ratio v₂ of the stator inner radius to the stator outer radius can be between 0.63 and 0.67 (0.63≤ratio v₂≤0.67), further preferably between 0.64 and 0.66 (0.64≤ratio v₂≤0.66). In a specific example, the ratio v₂ of the stator inner radius to the stator outer radius can be 0.65 (ratio v₂=0.65). Efficiency can be further optimized by the configuration of the stator body with these ratios.

Preferably, the stator outer radius can be between 105 mm and 142.5 mm (millimeters). This contributes to comparatively low friction losses and an increased efficiency. In particular, the stator outer radius can be between 115 mm and 132.5 mm, further preferably between 120 mm and 127.5 mm. In one specific example, the stator outer radius can be 122.5 mm.

Preferably, two stator grooves or three stator grooves can be provided on the stator body per pole and per strand (one stator winding). Several conductor elements can form a/the strand (one stator winding). In other words, the number of holes (number of stator grooves per pole and strand) is q=2 or q=3. This leads to efficiency advantages and a compact design space.

Preferably, the ratio v₃ of the stator tooth width to the stator groove width, in particular with two stator grooves per pole and per strand, can be between 0.50 and 0.75 (0.50≤ratio v₃≤0.75). In particular, the ratio v₃, in particular with two stator grooves per pole and per strand, can be between 0.55 and 0.70 (0.55≤ratio v₃≤0.70), further preferably between 0.60 and 0.65 (0.60≤ratio v₃≤0.65).

Alternatively, the ratio v₃ of the stator tooth width to the stator groove width, in particular with three stator grooves per pole and per strand, can be between 1.05 and 1.50 (1.05≤ratio v₃≤1.50). In particular, the ratio v₃, in particular with three stator grooves per pole and per strand, can be between 1.15 and 1.40 (1.15≤ratio v₃≤1.40), further preferably between 1.20 and 1.35, (1.20≤ratio v₃≤1.35), and further preferably between 1.25 and 1.30 (1.25≤ratio v₃≤1.30). In a specific example, the ratio v₃ can be=1.27. With the stated ratios v₃, a large stator tooth width can be achieved, whereas the stator groove width is comparatively low. Thus, an increased percentage of sheet metal can be achieved, which reduces iron losses. This is accompanied by a high current density.

The electrical machine can, for example by fine-tuning the ratio v₃, be configured to achieve with maximum current a maximum current density of greater than 40 A/mm² (amperes/square millimeter), preferably greater than 45 A/mm², further preferably between 45 and 60 A/mm², in particular between 50 and 60 A/mm².

Preferably, the electrical machine can have a pole pair number p of p=3 (3 pole pairs, i.e. a total of 6 poles). A sufficiently high number of pole pairs can thus be achieved in a comparatively compact design space.

The comparatively low frequency of the pole pair number of p=3 offers efficiency advantages, in particular in connection with the geometrical ratios given above.

Preferably, at each radially inner end of the stator teeth, a respective tooth head can be formed with a cross-section that is respectively enlarged relative to the stator teeth (or the stator tooth cross-section outside of the tooth head). This regularly favors higher efficiency and a high current density. The tooth heads can each extend radially along a defined tooth head height.

Preferably, a can can be arranged radially inside abutting the stator body, wherein the can covers the stator grooves when viewed in the radial direction i.e. radially inwardly. As a result, a sealing of the stator space relative to the rotor space can be provided. The stator grooves can be formed so to be open radially inwardly and covered by the can. For example, the can can abut the stator teeth or their tooth heads. The can is produced, for example, as a preferably fiber-reinforced plastic tube. However, the can can also be made of an elastic and/or flexible material attached to the stator body. For example, the can can be configured as a radially inner liner of the stator.

The electrical machine comprises an in particular dry-running rotor, which cooperates electromagnetically with the stator. The rotor has a rotor outer radius that is smaller than the stator inner radius by a radially oriented air gap height (air gap). The can can also be arranged in the air gap. In particular, a clearance fit can be configured between the can and a rotor that is electromagnetically drivable radially within the stator.

The can can seal the rotor against the stator so that the rotor cannot be wetted by any cooling medium present on the stator. Liquid friction with the cooling medium can be avoided by the in particular dry-running rotor. An air gap can be formed between the can and the rotor so that the rotor that is rotatable relative to the stator does not rub against the can. The rotor can in particular be connectable to a drive train of the motor vehicle, so that the motor vehicle can be driven purely electrically with the aid of the electrical machine.

Preferably, the stator body can be formed from a sheet metal package in which several stator sheet metal plates are arranged one behind the other along an axial direction, wherein the stator sheet metal plates each have a sheet metal thickness of 0.25 mm or less. This helps to operate the electrical machine efficiently at high powers. In particular, the stator sheet metal plates can have a sheet metal thickness of 0.10 mm to 0.25 mm.

Specifically, the stator body can be made of a sheet metal package in which several stator sheet metal plates, which are produced from a metal sheet metal in particular by punching, are arranged on behind the other in the axial direction and, preferably fluid-tightly, pressed together. In particular, the stator body can be manufactured inexpensively by punch-packaging.

Preferably, the electrical machine can comprise a cooling device, wherein the cooling device comprises several cooling channels each extending axially from an inlet (cooling channel inlet) or along the axial direction through the stator body to an outlet (cooling channel outlet), wherein the cooling channels are each filled with a dielectric material serving as a cooling medium or guide the dielectric material serving as a cooling medium. As a result, heat generated during operation of the electrical machine on the stator can be reliably dissipated.

The electrical machine can optionally comprise a housing, which can comprise a first subhousing and a second subhousing.

The first subhousing can be arranged at a first axial end of the stator and, together with the can and the front face of the stator, can define a first end volume, which can be configured, for example, as an annular space. The first end volume is fluidly connected to the cooling channels (cooling channel inlet) in the stator and filled with dielectric material serving as the cooling medium. The winding heads configured on the conductor elements can be arranged in the first end volume. Irrespective of the foregoing, an inlet for supplying cooling medium can be configured on the first subhousing.

The second subhousing can be arranged at a second end, in particular at the other axial end of the stator, and, together with the can and the end face of the stator, can define a second end volume, which can be configured, for example, as an annular space. The second end volume is fluidly connected to the cooling channels (cooling channel outlet) in the stator and filled with dielectric material serving as the cooling medium. If necessary, winding heads configured on the conductor elements can be arranged in the second end volume. Irrespective of the foregoing, an outlet for the dissipation of cooling medium can be formed on the second subhousing.

The outlet on the second subhousing can be fluidly connected to the inlet on the first subhousing. In this fluid connection, a fluid pump for conveying the cooling medium, one or more heat exchangers for cooling the cooling medium, and/or a cooling medium reservoir can be incorporated.

The cooling channels provided in the stator body can be formed separately from the stator grooves. Thus, a flow resistance can be kept low, because the cooling medium in the cooling channel can “flow freely” and does not have to pass through or flow around the conductor elements (flow obstruction). The cooling channels can each extend axially or along the axial direction through the stator body. The central longitudinal axes of the cooling channels can each be arranged parallel to the central longitudinal axes of the stator grooves.

Alternatively, the cooling channels can each be arranged in one of the stator grooves so that the conductor elements are cooled with the dielectric material serving as the cooling medium over the entire axial length of the stator body, in particular (relative to the conductor elements) “externally” through the cooling medium. In other words, the cooling channels each coincide with the stator grooves (the stator groove being simultaneously the cooling channel). The conductor elements arranged in the stator groove, which are each provided with an insulation layer, can thereby be cooled directly by the cooling medium (direct contact of cooling medium or dielectric material with the conductor elements). Even at comparatively high current densities, sufficient cooling is thus possible. The direction of flow of the cooling medium is oriented in particular along or parallel to the central longitudinal axis of the conductor elements.

A flow around the conductor elements with the cooling medium, in particular with oil, can thus also occur inside the stator groove and, provided the first subhousing (first end volume) and/or the second subhousing (second end volume) are present, on the winding head(s) (portions of the conductor elements axially projecting from the stator body).

Preferably, the dielectric material can have a maximum density of 0.75 kg/l at 15° C. and/or a maximum viscosity of 6 mm²/s at 40° C. and/or a minimum thermal capacity of 2.3 kJ/(kg*K) at 80° C. and/or a minimum thermal conductivity of 0.12 W/(m/K) at 80° C. and/or a maximum electrical conductivity of 1000 nS/m at 25° C. Advantageous cooling properties can thereby be achieved.

Preferably, the electrical machine can be configured as a permanently stimulated synchronous machine or an externally stimulated synchronous machine.

Further advantageous configurations of embodiments of the invention will emerge from the following description and the drawing. The drawing shows:

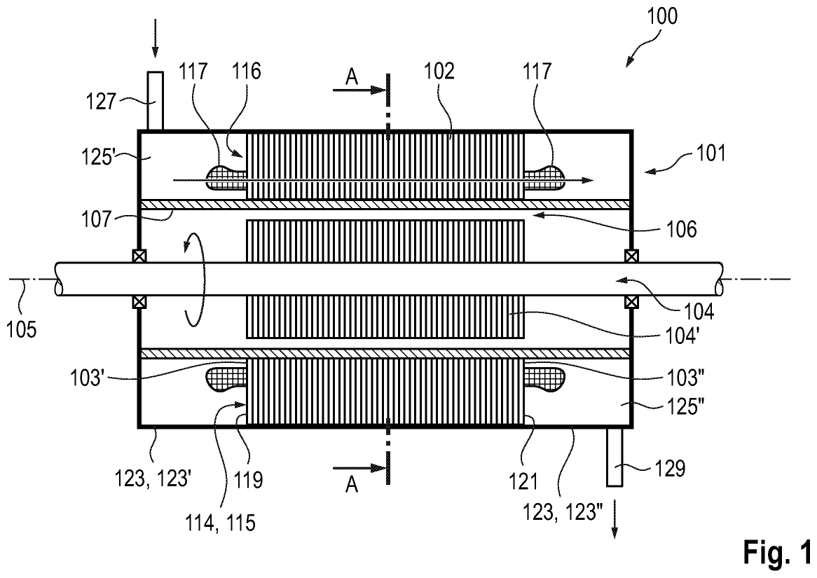

In FIG. 1, a longitudinal section through an electrical machine 100 is schematically shown.

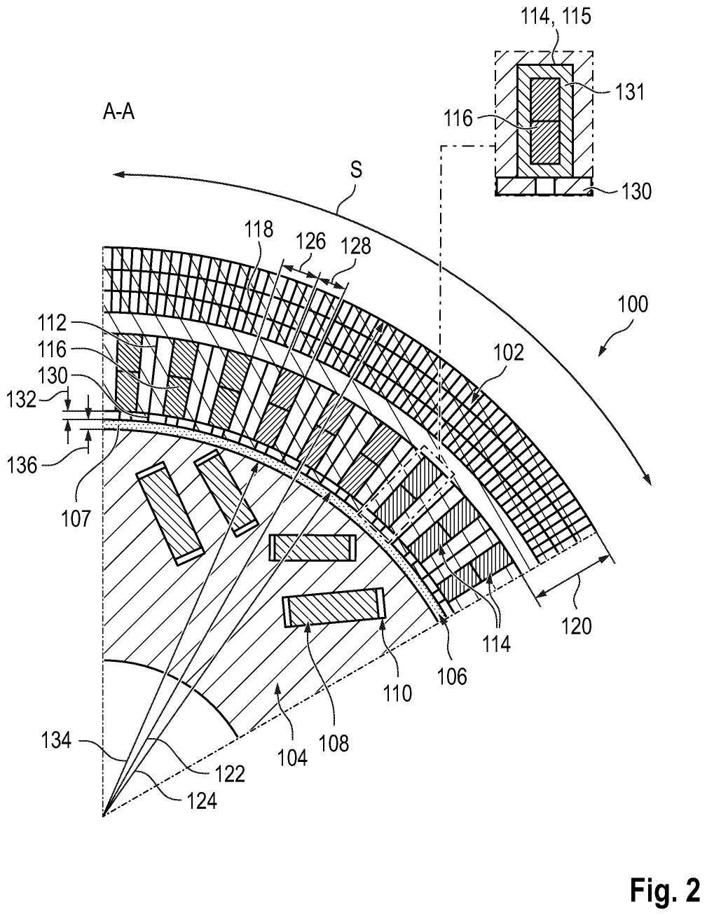

The electrical machine 100 comprises a stator 101 having a stator body 102, as well as a rotor 104 having a permanent magnet 104′. The axial direction bears the reference number 105. The stator body 102 surrounds the rotor 104 radially outwardly, wherein the stator body 102 and the rotor 104 are separated from one another by an air gap 106. A can 107 is arranged in the air gap 106, which separates the space in which the rotor 104 is arranged (rotor space) from the space in which the stator 101 is arranged (stator space). In the example, several magnets 108 are arranged in the rotor 104, which are optionally equipped with air pockets 110 (cf. FIG. 2).

The stator body 102, the design of which is explained in further detail below, alternately comprises stator teeth 112 and stator grooves 114 along a circumferential direction with conductor elements 116 arranged therein (cf. FIG. 2). The conductor elements 116 each comprise portions axially projecting from the stator body 102, which form winding heads 117 (cf. FIG. 1).

The electrical machine 100 comprises a cooling device having several cooling channels 115, each extending from an inlet 119 through the stator body 102 to an outlet 121. The cooling channels 115 are each filled with a dielectric material 131 serving as the cooling medium (cf. FIG. 2). In the example, the cooling channels 115 coincide with the respective stator grooves 114. The cooling medium or dielectric material is thus guided directly along the conductor elements 116, which in the example are “externally” surrounded by the flow. The dielectric material 131 can have the properties explained above.

The electrical machine 100 comprises a housing 123, which comprises a first subhousing 123′ and a second subhousing 123″ (cf. FIG. 1). The first subhousing 123′ is arranged at a first axial end of the stator body 102 and, together with the can 107 and the end face 103′ of the stator body 102, defines a first end volume 125′, which in the example is configured as an annular space. The first end volume 125′ is fluidly connected to the cooling channels 115 (cooling passage inlet) in the stator body 102 and filled with dielectric material 131 serving as the cooling medium. In the first end volume 125′, the winding heads 117 formed on the conductor elements 116 are arranged. An inlet 127 for supplying cooling medium is configured on the first subhousing 123′.

The second subhousing 123″ is arranged at the other axial end of the stator body 102 and, together with the can 107 and the end face 103″ of the stator body 102, defines a second end volume 125″, which in the example is configured as an annular space. The second end volume 125″ is fluidly connected to the cooling channels 115 (cooling passage outlet) in the stator body 102 and filled with dielectric material 131 serving as the cooling medium. In the second end volume 125″, the winding heads 117 formed on the conductor elements 116 are arranged. An outlet 129 for dissipating cooling medium is configured on the second subhousing 123″. The outlet 129 can be fluidly connected to inlet 127, as explained above.

In FIG. 2, a segment S or a partial section (cross-section) through an electrical machine 100 is schematically shown according to the section axis A-A in FIG. 1. As explained above, the stator body 102 alternately comprises stator teeth 112 and stator grooves 114 having conductor elements 116 arranged therein along a circumferential direction. On the stator body 102, a yoke portion 118 having a radially extending yoke height 120 is formed radially outside of the stator grooves 114 and the stator teeth 112, wherein the stator body 102 comprises a stator outer radius 122. In the example, the ratio v₁ of the yoke height 120 to the stator outer radius 122 is between 0.18 and 0.26 (0.18≤v₁≤0.26).

The stator body 102 has a stator inner radius 124. In the example, the ratio v₂ of the stator inner radius 124 to the stator outer radius 122 is between 0.61 and 0.69 (0.61≤v₂≤0.69). In the example, the stator outer radius 122 is between 105 mm and 142.5 mm.

In the example, the electrical machine 100 has a pole pair number p of p=3 (a total of 6 poles). In the example, three stator grooves 114 are provided on the stator body 102 per pole and the conductor elements 116 forming a strand or a conductor winding (in FIG. 2, three stator grooves 114, similarly shown, correspond to one strand). In other words, the number of holes (number of stator grooves 114 per pole and strand) q=3.

The stator teeth 112 each have a stator tooth width 126. The stator grooves 114 each have a stator groove width 128. In the example, the ratio v₃ of the stator tooth width 126 to the stator groove width 128 is between 1.05 and 1.50 (1.05≤v₃≤1.50).

At the radially inner end of the stator teeth 112, a respective tooth head 130 is formed with an enlarged cross-section relative to the stator teeth 112. The tooth heads 130 each extend along a defined tooth head height 132.

The rotor 104 has a rotor outer radius 134, wherein the rotor outer radius 134 is smaller than the stator inner radius 124 by a radially oriented height 136 of the air gap 106 (air gap height 136). The can 107 is also arranged in the air gap 106.

As indicated above, the conductor elements 116 are directly cooled. For this purpose, in the example, a cooling channel 115 is provided in each stator groove 114 (stator groove 114 and cooling channel 115 coincide), wherein the conductor elements 116 are cooled over the entire axial length of the stator body 102 with the dielectric material 131 serving as the cooling medium and surrounded externally by the flow thereof (cf. enlarged section in FIG. 2).

The stator grooves 114 are opened radially inward and are covered or closed by the can 107. The can 107 abuts the tooth heads 130 of the stator teeth 112.

As already explained above, the stator body 102 is formed from a sheet metal package in which several stator sheet metal plates are arranged one behind the other along the axial direction 105, wherein the stator sheet metal plates each have a sheet metal thickness of 0.25 mm or less (cf. FIG. 1).

The electrical machine 100 shown in FIGS. 1 and 2 can be used for purely electric drive of a motor vehicle. For this purpose, the electrical machine 100 can be powered from a motor vehicle battery connected to the conductor elements 116 in order to generate an electrically generated magnetic field in the stator 101, which can cooperate with permanent magnets 104′ of the in particular dry-running rotor 104.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An electrical machine for a motor vehicle, comprising:
a stator including a stator body, wherein the stator body includes alternating stator teeth and stator grooves having conductors arranged therein,
wherein a yoke portion having a radially extending yoke height is formed on the stator body radially outside of the stator grooves,
wherein the stator body comprises a stator outer radius, and
wherein a ratio of the yoke height to the stator outer radius is between 0.18 and 0.26.

2. The electrical machine according to claim 1, wherein the stator body comprises a stator inner radius, and
wherein a ratio of the stator inner radius to the stator outer radius is between 0.61 and 0.69.

3. The electrical machine according to claim 1, wherein the stator outer radius is between 105 mm and 142.5 mm.

4. The electrical machine according to claim 1, wherein the stator includes one or more poles and one or more winding strands, and
wherein two or three of the stator grooves are provided on the stator body per pole and per winding strand of the stator.

5. The electrical machine according to claim 1, wherein a ratio of a stator tooth width to a stator groove width is between 0.50 and 0.75, or the ratio of the stator tooth width to the stator groove width is between 1.05 and 1.50.

6. The electrical machine according to claim 1, comprising a pole pair number of 3.

7. The electrical machine according to claim 1, wherein at each radially inner end of the stator teeth, a respective tooth head is formed with a cross-section that is enlarged relative to the stator teeth.

8. The electrical machine according to claim 1, wherein a can is arranged radially inside of the stator body and abutting the stator body, and
wherein the can covers the stator grooves when viewed in a radial direction.

9. The electrical machine according to claim 1, wherein the stator body is formed from a sheet metal package in which several stator sheet metal plates are arranged one behind the other along an axial direction, and
wherein the stator sheet metal plates each have a sheet metal thickness of 0.25 mm or less.

10. The electrical machine according to claim 1, comprising a cooling device,
wherein the cooling device includes cooling channels, each extending from an inlet along an axial direction through the stator body to an outlet, and
wherein the cooling channels are each filled with a dielectric material configured as a cooling medium.

11. The electrical machine according to claim 10, wherein the cooling channels are each arranged in one of the stator grooves, such that the conductors are cooled over an entire axial length of the stator body with the dielectric material.

12. The electrical machine according to claim 10, wherein the dielectric material has a maximum density of 0.75 kg/l at 15° C. and/or a maximum viscosity of 6 mm²/s at 40° C. and/or a minimum thermal capacity of 2.3 kJ/(kg*K) at 80° C. and/or a minimum thermal conductivity of 0.12 W/(m/K) at 80° C. and/or a maximum electrical conductivity of 1000 nS/m at 25° C.

13. The electrical machine according to claim 1, wherein the electrical machine is configured as a permanently stimulated synchronous machine or as an externally stimulated synchronous machine.
